(19) United States
(12) Patent Application Publication
(10) Pub. No.: US 2011/0027694 A1
(43) Pub. Date: Feb. 3, 2011

(54) Solid-oxide fuel cells with concentric laminating electrolytes in a nanoporous membrane

(76) Inventors: Cheng-Chieh Chao, Stanford, CA (US); Friedrich B. Prinz, Woodside, CA (US); Turgut M. Gür, Palo Alto, CA (US); Joon Hyung Shim, Seoul (KR)

Correspondence Address: LUMEN PATENT FIRM, 350 Cambridge Avenue, Suite 100, PALO ALTO, CA, 94306, US

(21) Appl. No.: 12/804,705

(22) Filed: Jul. 26, 2010

Related U.S. Application Data
(60) Provisional application No. 61/273,404, filed on Aug. 3, 2009.

(51) Int. Cl. H01M 8/10

(52) U.S. Cl. 429/496; 429/495

(57) ABSTRACT

A solid oxide fuel cell with an electrolyte membrane having one or more layers with interfaces perpendicular to the surfaces of the membrane is provided. The layers can be deposited on vertical walls of holes in a nanoporous membrane until the layers fully fill the holes, thereby forming superlattices in the holes. The final shape of the superlattices in this example will be concentric, laminating layers as seen in a top view looking down on the membrane. According to one aspect, conventional electrodes can be deposited on both sides of the membrane for current collection and surface charge transfer reactions.

### CROSS-REFERENCE TO RELATED APPLICATIONS

This application claims priority from U.S. Provisional Patent Application 61/273,404 filed Aug. 3, 2009, which is incorporated herein by reference.

### FIELD OF THE INVENTION

The invention relates to fuel cells. More particularly the invention relates to electrolyte membranes for solid oxide fuel cells.

### BACKGROUND OF THE INVENTION

Ion-conducting oxides have attracted attention as electrolyte membranes of fuel cells. Introduction of dopant anions forms vacant sites by removing cations or oxygen ions in the crystal oxide structure for overall charge neutrality. Doped oxides can conduct oxide ions through those vacant sites. However, the high operational temperature of solid oxide fuel cells (SOFC), which is typically around 800-1000 C to achieve reasonable ionic conductivity, has led to limited use of the device.

There have been various attempts to enhance ion conduction through electrolytes and to reduce operation temperature of SOFC including incorporation of nanoscale thickness membranes or highly conductive materials.

However, even oxides having the highest known ionic conductivity exhibit relatively low conductivity, especially compared to polymer-type membranes operable at room temperature. There is no oxide existing that is practically useful for operation at room temperature or even below 200° C. Furthermore, a main limitation of nanoscale electrolytes is high cost of manufacturing, which is less attractive for commercial use in industry.

Although prototype fuel cells with nanoscale ceramic membranes have been demonstrated, such cells are usually mechanically fragile in practice.

What is needed is a low-cost SOFC membrane that provides high ionic conductivity at temperatures as low as below 200° C.

### SUMMARY OF THE INVENTION

To address the need in the art, a fuel cell electrolyte membrane is provided that includes a nanoporous membrane having nanopores, where the nanopores span from a top surface of the nanoporous membrane to a bottom surface of the membrane. The electrolyte membrane further includes an oxide ion-conducting layer deposited along the walls of the nanopores, where an interface along the oxide ion-conducting layer provides enhanced diffusion of oxide ions between the top surface and the bottom surface.

According to one aspect of the invention, the ion-conducting layer includes alternating layers of the oxide ion-conducting layers that are different from each other, where the alternating different layers are disposed to fill the nanopores. In one aspect, the alternating layers are concentric alternating layers.

In a further aspect of the invention, the at least one oxide ion-conducting layer can be made from material that includes yttria stabilized zirconia (YSZ), gadolinia doped ceria (GDC), yttria doped ceria (YDC), scandinia doped zirconica (SDZ), or samaria doped ceria (SDC).

According to another aspect of the invention, the oxide ion-conducting layer has a thickness in a range of 1 nm to 250 nm.

In another aspect of the invention, the oxide ion-conducting layer is provided produced by atomic layer deposition (ALD) of or chemical layer deposition (CVD).

In yet another aspect, the nanoporous membrane has a thickness in a range of 10 μm to 1 mm.

In one aspect of the invention, the nanopores have a hole diameter size in a range of 50 nm to 500 nm.

According to a further aspect of the invention, the nanopores have a cross-section shape that can include circular, square, rectangular, polygon or irregular.

In another aspect of the invention, a spacing between the nanopores is in a range of 50 nm to 500 nm.

In a further aspect of the invention, the nanoporous membrane is made from material that can include a porous alumina anodized oxide substrate or any non-electronically conducting material.

### BRIEF DESCRIPTION OF THE DRAWINGS

FIG. 1 shows a perspective cutaway view of a nanoporous substrate having concentric oxide ion-conducting layers disposed therein, according to the current invention.

FIG. 2 shows a planar cutaway view of a nanoporous substrate with arrows representing oxide ion-conduction between the concentric layers, according to the current invention.

FIG. 3 shows a planar cutaway view of a single nanopore in the substrate having oxide ion-conducting layers disposed therein with arrows showing oxide ion-conduction between the concentric layers and conductor material disposed on each side of the membrane, according to the current invention.

### DETAILED DESCRIPTION

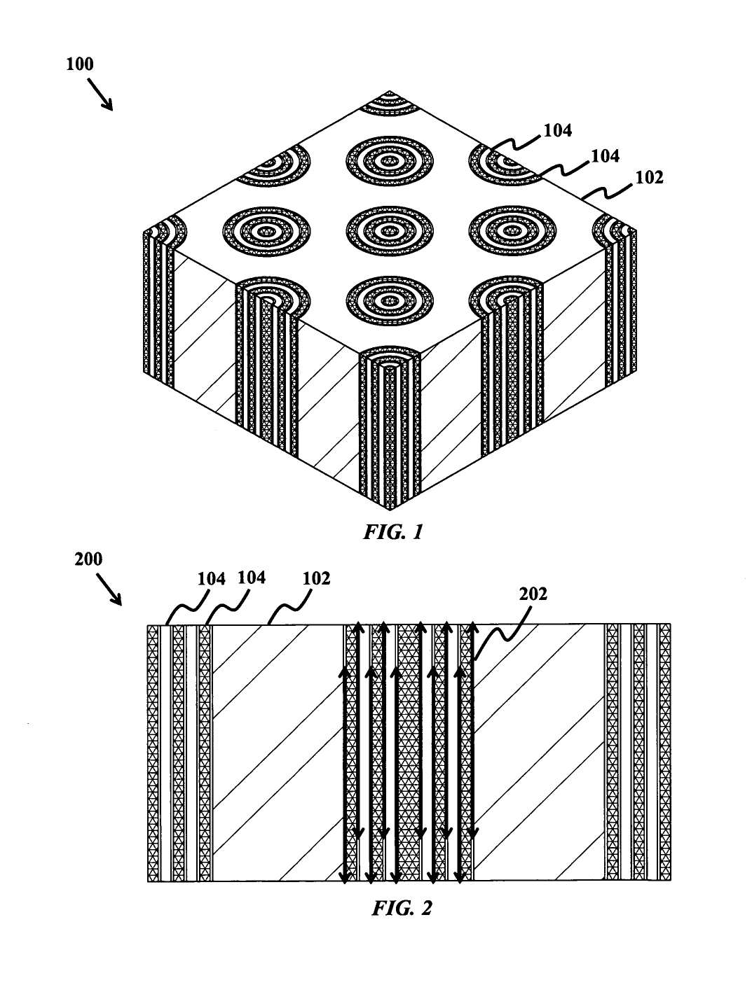

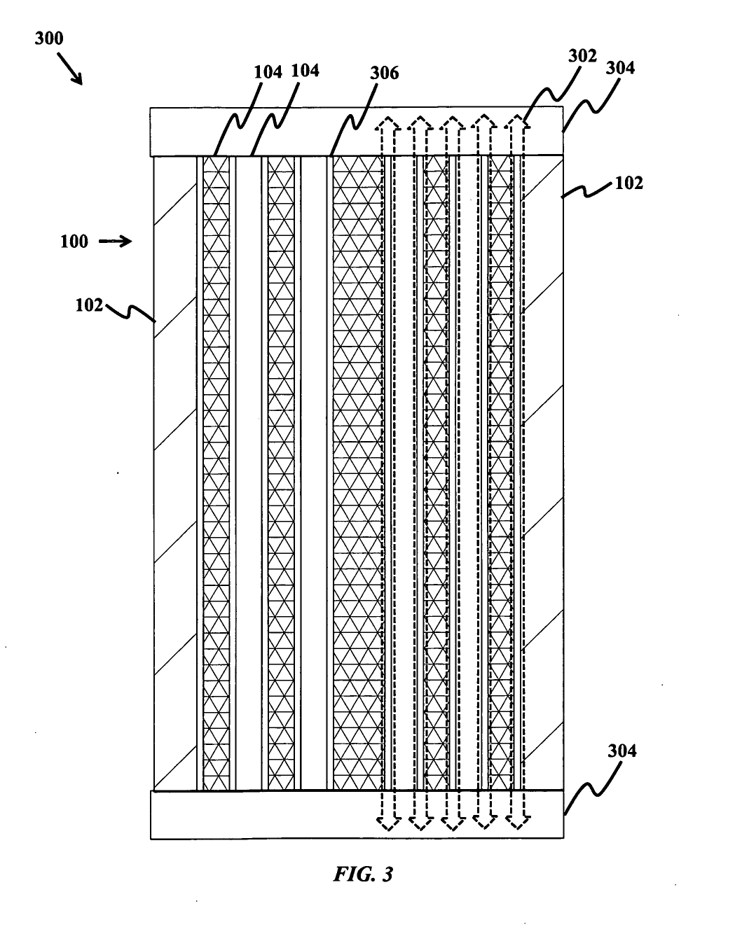

To address these problems, the current invention provides a solid oxide fuel cell with an electrolyte membrane having multiple layers with interfaces perpendicular to the surfaces of the membrane. FIG. 1 shows a perspective cutaway view of ion-conducting membrane 100, showing a nanoporous substrate 102 having concentric oxide ion-conducting layers 104 disposed therein. FIG. 2 shows a planar cutaway view 200 of a nanoporous substrate 102 with arrows 202 representing oxide ion-conduction between the concentric layers 104. The layers 104 are deposited on vertical walls of holes in the nanoporous membrane 102 until the layers 104 fully fill the holes, thereby forming superlattices in the holes. The final shape of the superlattices in this example are concentric, laminating layers 104 as seen from a top view looking down on the membrane 100. According to one aspect of the invention, conventional electrodes (see FIG. 3) can be deposited on both sides of the membrane 100 for current collection and surface charge transfer reactions.

FIG. 3 shows a planar cutaway view of a single nanopore 300 in the substrate 102 having oxide ion-conducting layers 104 disposed therein with arrows 302 showing oxide ion-conduction along the interface 306 between the concentric layers 104 and electrodes 304 disposed on each side of the membrane 100. According to the invention, ions are conducted dominantly along the interfaces 306 between alternating layers 104 with greatly enhanced ionic conductivity or diffusivity, where the enhanced ionic conductivity is several orders of magnitude higher at the interfaces between oxide ion conductors and substrates on which the films were deposited. This enhancement occurs in superlattices having alternating layers 104 of oxide ion conductors and substrate materials multiple interfaces exist between layers. Another aspect of the invention, the interfaces between crystal doped oxide grains also enhance diffusion of oxide ions. This approach for fuel cell electrolytes provides high effective ionic conductivity, thereby reducing resistance of electrolytes and saving operational energy in solid oxide fuel cells. Exemplary applications of such electrolyte membranes include: solid oxide fuel cells, oxygen sensors, oxygen separators or purifiers, and oxygen pumps.

Significant advantages are provided. The current invention enables operation of SOFC at low temperatures, for example below 200° C., and possibly at around room temperature. Although the ionic conductivity of the materials in the lamination layers is too low for operation at room temperature, interfacial conductivity can overcome this sluggish ion transport through bulk, since the expected conductivity enhancement is about 5-6 orders of magnitude. Furthermore, the current invention alleviates the need for nanothickness membranes because the superlattice layers are deposited in holes of a mechanically stable porous membrane.

Exemplary materials useful for the laminating layers in the electrolytes include oxide ion-conducting oxides such as yttria stabilized zirconia (YSZ), gadolinia doped ceria (GDC), yttria doped ceria (YDC), scandinia doped zirconica (SDZ), and samaria doped ceria (SDC). According to the invention, exemplary laminations can be completed as (porous membrane surface)-(laminating layer A)-(laminating layer B)-A-B-A-B- . . . until it completely fills the membrane hole. The material B can be the same as the support membrane material, or it can be different. Thickness of each layer can be from 1 nm to 250 nm. The upper end of the layer thickness range depends on the size of the holes being filled for example, 500 nm diameter holes can have a maximum layer thickness of 250 nm).

Exemplary methods to fabricate laminating layers in the nano-holes include chemical vapor deposition (CVD) and atomic layer deposition (ALD) for conformal coating on the vertical walls.

Exemplary materials useful as a supporting nanoporous membrane include commercially available alumina anodized oxide (AAO) porous membranes or custom-made nanoporous oxide membranes. Thickness of the membrane can be from 10 μm to 1 mm, which is sufficiently thick, especially at the upper end of this range, to be used as a free-standing membrane. Hole size can be from 50 nm to 500 nm diameter (or diagonal), which is small enough to be able to be filled in by ALD or CVD techniques. Hole shape can be circular, square, rectangular, or any other shape. Spacing between holes can be 50 nm to 500 nm, which is large enough to support nano-laminating layers in the holes.

Suitable cathode materials include catalytic metals such as Pt, Pt-metal alloys, Ag, and Ag-metal alloys or various mixed electron-ion conductors such as lanthanum strontium cobalt iron oxide (LSCF), lanthanum strontium manganese (LSM), barium strontium cobalt iron oxide (BSCF), Strontium doped Samarium Cobaltite (SSC), cermets mixed with the preceding listed metal-metal alloys and mixed electron-ion conductors, and cermets mixed with the preceding listed electrolyte materials.

Suitable anode materials include catalytic metals such as Pt, Pt-metal alloys, Ag, Ag-metal alloys, Ni, Ni-metal alloys, Ru, Rumetal alloys, Pd, Pd-alloys, cermets mixed with the preceding listed metal-metal alloys, and cermets mixed with the preceding listed electrolyte materials.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example the fuel cells can be implemented in the electrolyte-supported structure with decoration of porous electrode layers or the electrolyte membranes can be implemented on porous electrode support mesh.

All such variations are considered to be within the scope and spirit of the present invention as defined by the following claims and their legal equivalents.

What is claimed:

1. A fuel cell electrolyte membrane comprising:
a. a nanoporous membrane comprising nanopores, wherein said nanopores span from a top surface of said nanoporous membrane to a bottom surface of said nanoporous membrane; and
b. an oxide ion-conducting layer deposited along the walls of said nanopores and disposed to fill said nanopores, wherein an interface along said oxide ion-conducting layer provides enhanced diffusion of oxide ions between said top surface and said bottom surface.

2. The fuel cell electrolyte membrane of claim 1, wherein said oxide ion-conducting layer comprises alternating layers of said oxide ion-conducting layers that are different from each other, wherein said alternating layers are disposed to fill said nanopores.

3. The fuel cell electrolyte membrane of claim 2, wherein said alternating layers are concentric alternating layers.

4. The fuel cell electrolyte membrane of claim 1, wherein said at least one oxide ion-conducting layer is made from material selected from the group consisting of yttria stabilized zirconia (YSZ), gadolinia doped ceria (GDC), yttria doped ceria (YDC), scandinia doped zirconica (SDZ), and samaria doped ceria (SDC).

5. The fuel cell electrolyte membrane of claim 1, wherein said oxide ion-conducting layer has a thickness in a range of 1 nm to 250 nm.

6. The fuel cell electrolyte membrane of claim 1, wherein said oxide ion-conducting layer is produced by atomic layer deposition (ALD) or chemical layer deposition (CVD).

7. The fuel cell electrolyte membrane of claim 1, wherein said nanoporous membrane has a thickness in a range of 10 μm to 1 mm.

8. The fuel cell electrolyte membrane of claim 1, wherein said nanopores have a hole diameter size in a range of 50 nm to 500 nm.

9. The fuel cell electrolyte membrane of claim 1, wherein said nanopores have a cross-section shape selected from the group consisting of circular, square, rectangular, polygon and irregular.

10. The fuel cell electrolyte membrane of claim 1, wherein a spacing between said nanopores is in a range of 50 nm to 500 nm.

11. The fuel cell electrolyte membrane of claim 1, wherein said nanoporous membrane is made from material selected from the group consisting of a porous alumina and any non-electronically conductive materials.
